(19) United States
(12) Patent Application Publication
(10) Pub. No.: US 2006/0191366 A1
(43) Pub. Date: Aug. 31, 2006

(54) Forward-reverse control device

(75) Inventors: Hendrikus Jan Kapaan, Nieuwegein (NL); Jacobus Zwarts, Nieuwegein (NL); Cornelius Petrus Antonius Vissers, Dun Dungen (NL); Emmanuel Jacques Eyraud, San Secondo di Pinerolo (IT)

Correspondence Address: THE WEBB LAW FIRM, P.C., 700 KOPPERS BUILDING, 436 SEVENTH AVENUE, PITTSBURGH, PA, 15219, US

(73) Assignee: AB SKF, Goteborg (SE)

(21) Appl. No.: 10/549,254

(22) PCT Filed: Dec. 3, 2004
(86) PCT No.: PCT/NL04/00180

§ 371 Date: Sep. 13, 2005

(51) Int. Cl. F16H 57/02

(52) U.S. Cl. 74/412 R

(57) ABSTRACT

A forward-reverse control device comprises a housing, a rotatable input member, having a rotatable output member, a gear set for reversing the input rotation, as well as a selector for selectively connecting the input member and the output member directly or through the gear set, wherein the selector is driveable by an electric actuator.

The invention is related to a forward-reverse control device, comprising a housing, a rotatable input member, a rotatable output member, a gear set for reversing the input rotation, as well as selector means for selectively connecting the input member and the output member directly or through the gear set.

Such a forward-reverse control device is known. It can for instance be applied in an automotive vehicle driveline including a continuously variable transmission. The object of the invention is to provide an improved independent forward-reverse control mechanism which can be applied in connection with drive-by-wire applications, in particular in connection with a drive-by-wire continuously variable transmission. The CVT by wire transmission may incorporate, apart from the forward reverse control by wire, also a disc variator by wire, clutch by wire with or without integrated starter generator, a differential with or without traction control and also a parking by wire control.

Said object is achieved in that the selector means are driveable by means of an electric actuator. Said actuator comprises an electric/mechanical converter for converting rotational motion into linear motion, e.g. a ball/screw mechanism connected to an electric motor. The ball screw mechanism may be a friction screw, a ball screw or al roller screw mechanism.

Preference is given to an embodiment in which each satellite gear of the planetary gear set is rotatably connected with respect to the housing, said housing furthermore supporting the screw mechanism and the electric motor. The selector means may comprise a toothed selector wheel which is displaceable in axial direction, a first counter wheel which is connected to the input member, a second counter wheel which is connected to the output member, as well as a third counter wheel which is connected to the ring gear of the planetary gear set and which is positioned between the first and the second counter wheel when seen in axial direction, said selector wheel being displaceable between a first position engaging both the third and the first counter wheel, and a second position engaging the third and the second counter wheel.

The screw of the screw mechanism may be rotatably supported with respect to two axially spaced support rings, said support rings each being suspended with respect to the housing by means of suspension rods extending between the ring gear and the sun gear of the satellite gear set, and the nut of the screw mechanism is connected to the selector wheel. Synchronizer mechanisms may be provided between the third and the first counter wheel as well as between the third and the second counter wheel.

The output member can be connected to the sun wheel, and the third counter wheel can be connected to the ring gear of the satellite gear set.

The invention will now be described further with reference to the embodiment shown in the drawings.

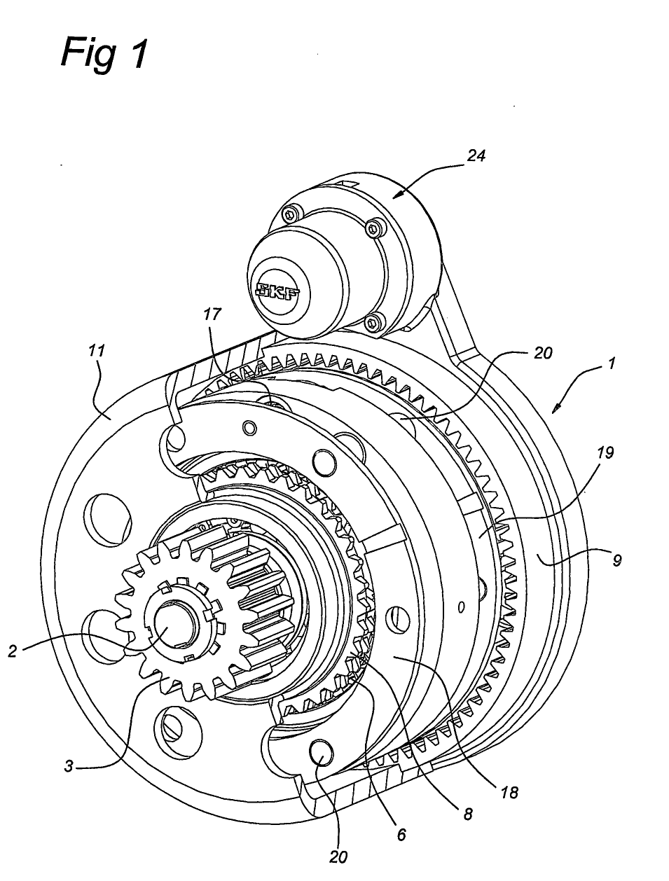

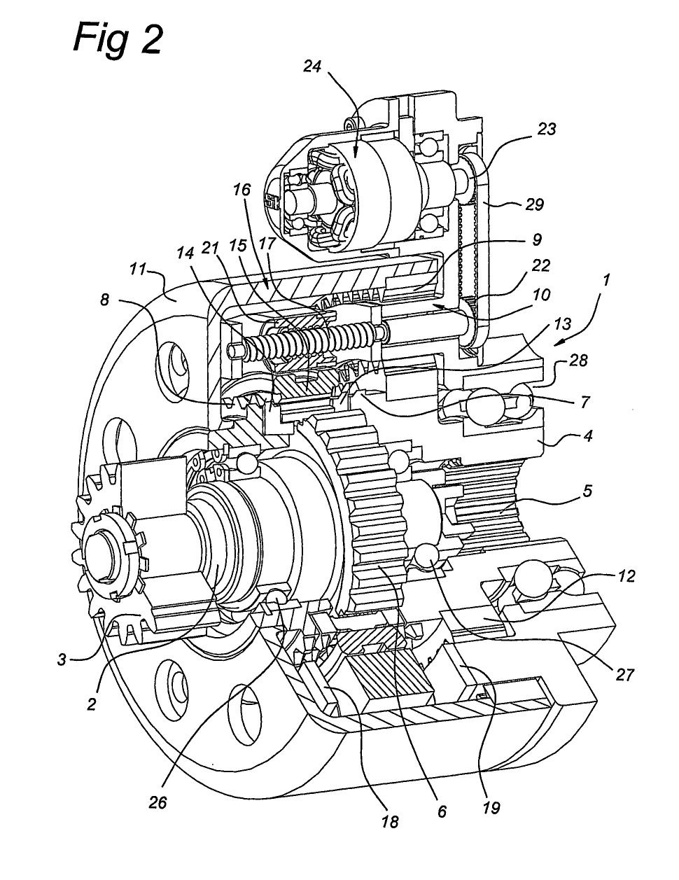

FIGS. 1 and 2 show a forward-reverse control device according to the invention in perspective and partly in radial cross section.

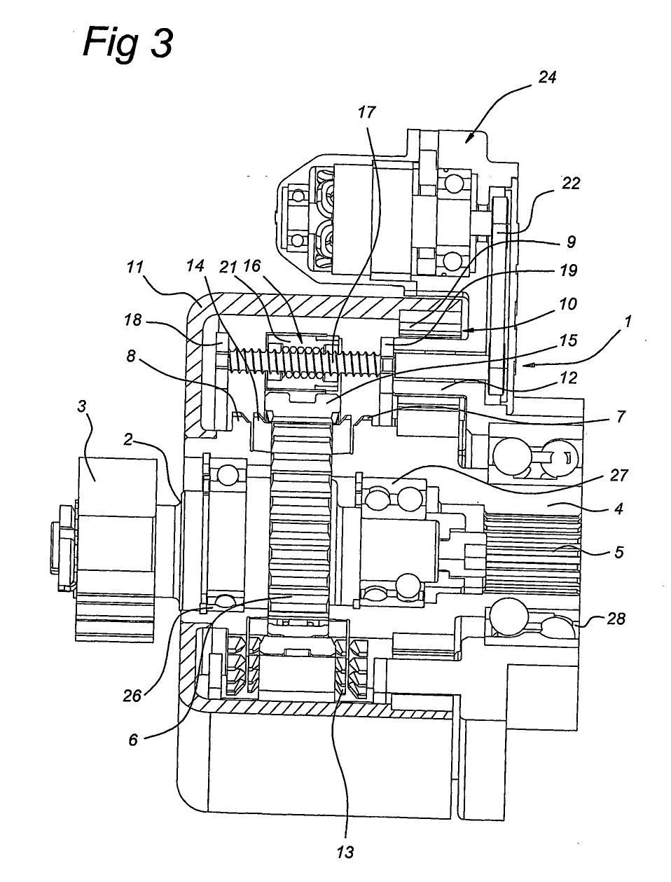

FIG. 3 shows a side view, partially in radial cross section.

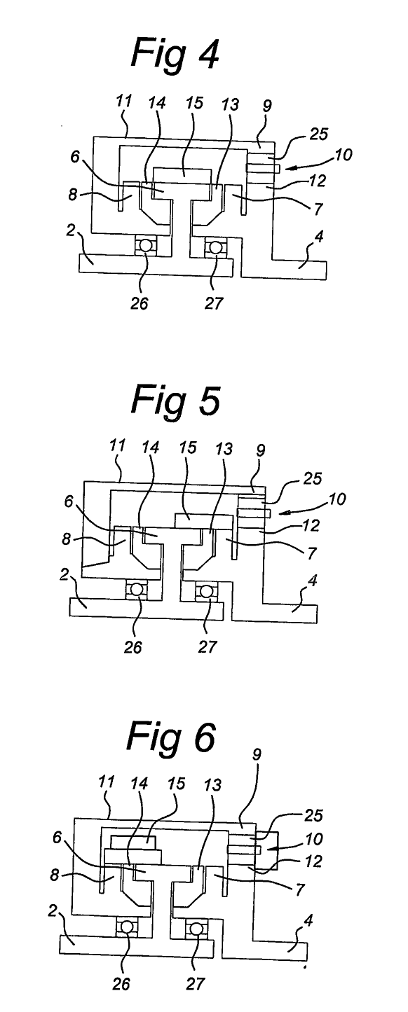

FIG. 4 up to 6 show several steps of the control mechanism.

The forward-control device as shown in the FIGS. 1, 2 and 3 comprises a housing 1 with a rotatable output shaft 2 onto which a pinion gear 3 has been mounted. Furthermore, the input shaft 4 has been provided with internal toothing 5 for engagement with a splined shaft.

A first counter gear wheel 6 is mounted on the output shaft 2, a second counter gear wheel 7 is connected to the input shaft 4 and a third counter gear wheel 8 is connected to the ring gear 9 of the planetary gear set which has indicated in full by reference numeral 10. Said ring gear is connected to the third counter gear wheel 8 by means of the housing part 11. The sun gear 12 of the planetary gear set 10 is connected to the input shaft 4.

Between the first counter gear wheel 6 and the second counter gear wheel 7 a synchronizer mechanism 13 has been applied, between the first counter gear wheel 6 and the third counter gear wheel 8 a synchronizer mechanism 14 has been applied.

The first counter gear wheel 6 engages an inwardly toothed selector gear wheel 15. This engagement between the first counter gear wheel 6 and the selector gear wheel 15 does not allow mutual rotations, but does allow the selector gear wheel 15 to be axially shifted with respect to the first counter gear wheel 6. This axially shifting movement is obtained by the screw mechanism 16, which comprises a screw shaft 17 rotatably supported in the two rings 18, 19. Said two rings are fixedly connected to the housing 1 by means of rods 20 which are regularly spaced in circumferential direction.

The screw mechanism 16 furthermore comprises a non rotatable nut 21, which is connected to the selector gear wheel 15. The screw 17 is driveable through the toothed belt 29 which engages the toothed wheel 22 connected to the screw 17, as well as the toothed wheel 23 connected to the electric motor 24 as supported by the housing 1.

The forward-reverse control device according to the invention is driven as follows. First of all, the neutral position of the forward-reverse control device according to the invention is shown in the FIGS. 3 and 4. By means of the screw mechanism 16, the selector gear wheel 15 is only in engagement with the first counter gear wheel 6. Thus, there is no mechanical drive connection between the input shaft 4 and the output shaft 2 as shown in FIGS. 4 and 5.

By driving the screw mechanism 16 through motor 24 and belt 22 in such a way that the selector gear wheel 15 moves to the right in comparison to the position shown in FIGS. 3 and 4, the state as shown in FIG. 5 is obtained. Through synchronizer mechanism 13 the selector gear wheel 15, which stays in engagement with the first counter gear wheel 6, now engages the second counter gear wheel 7. Thus, a direct connection is obtained between the input shaft 4 and the output shaft 2, e.g. for forward drive.

By moving the selector gear wheel 15 to the left as shown in FIG. 6, a connection is established between the third counter gear wheel 8 and the first counter gear wheel 6. Now, the input shaft 4 drives the ring gear wheel 9, which through the satellite gear wheels 25 makes the output shaft 2 rotate in opposite direction. Here as well, a synchronizer mechanism 14 is available for enabling a smooth transition to the backward drive motion.

Several bearings have been applied so as to support the several rotatable components. The output shaft 2 is rotatably supported with respect to the third counter gear wheel 8 by means of the ball bearing 26. Also, the output shaft 2 is rotatably supported with respect to the input shaft 4 by means of the double ball bearing 27. The input shaft 4 is moreover supported with respect to the housing 1 by means of a bearing 28.

The output shaft can indirectly or directly drive the crown wheel of a differential. The drive means may comprise a gear-chain- or toothed belt transmission or a combination thereof The input shaft and the output shaft can be part of a primary or secondary shaft of a CVT transmission. The forward-reverse control device can be an add-on module mounted on a clutch, or a clutch by wire or a clutch by wire with an integrated starter generator.

The forward-reverse control by wire forms a self contained by wire system comprising also a variator disc by wire control, clutch by wire control with or without integrated starter generator, a differential with or without traction control and parking wire control (optional) for a self contained CVT.

1-8. (canceled)

9. A forward-reverse control device, comprising a housing, a rotatable input member, a rotatable output member, a planetary gear set for reversing the input rotation, selector means for selectively connecting the input member and the output member directly or through the gear set, wherein the selector means are driveable by means of an electric actuator, wherein each satellite gear of the planetary gear set is rotatably connected with respect to the housing, said housing furthermore supporting the screw mechanism and the electric motor.

10. The device according to claim 9, wherein the electric actuator comprises an electric/mechanical converter for converting rotational motion into linear motion.

11. The device according to claim 10, wherein the linear screw mechanism is one from the group of a friction screw, a ball screw and a roller screw mechanism.

12. The device according to claim 9, wherein the selector means comprises a toothed selector gear wheel which is displaceable in the axial direction, a first counter gear wheel which is connected to the input member, a second counter gear wheel which is connected to the output member, a third counter gear wheel which is connected to the ring gear of the planetary gear set, the second counter gear wheel being positioned between the first and the third counter gear wheel when seen in axial direction, said selector gear wheel being displaceable between a first position engaging both the second and the first counter gear wheel, and a second position engaging the second and the third counter gear wheel.

13. The device according to claim 12, wherein the screw of the screw mechanism is rotatably supported with respect to two axially spaced support rings, said support rings each being suspended with respect to the housing by means of suspension rods extending between the ring gear and the sun gear of the satellite gear set, and the nut of the screw mechanism is connected to the selector wheel.

14. The device according to claim 12, wherein synchronizer mechanisms are provided between the second and the first counter wheel as well as between the second and the third counter wheel.

15. The device according to claim 12, wherein the input member is connected to the sun wheel, and the third counter wheel is connected to the ring gear of the satellite gear set.

16. The device according to claim 10, wherein the ball/screw mechanism is connected to an electric motor.
